(19) United States
(12) Patent Application Publication
(10) Pub. No.: US 2024/0330481 A1
(43) Pub. Date: Oct. 3, 2024

(54) CLASSIFYING SECURITY VULNERABILITIES BASED ON A BODY OF THREAT INTELLIGENCE

(71) Applicant: Cisco Technology, Inc., San Jose, CA (US)

(72) Inventors: Michael Roytman, Swannanoa, NC (US); Vincent Parla, North Hampton, NH (US); Andrew Zawadowskiy, Hollis, NH (US); William Michael Hudson, JR., Cary, NC (US)

(21) Appl. No.: 18/494,521

(22) Filed: Oct. 25, 2023

Related U.S. Application Data
(60) Provisional application No. 63/493,552, filed on Mar. 31, 2023.

(51) Int. Cl. G06F 21/57; G06F 21/31; G06F 21/55

(52) U.S. Cl. CPC G06F 21/577; G06F 21/31; G06F 21/552

(57) ABSTRACT

A system and method are provided for predicting the method of exploitation and impact/scope of software vulnerabilities, thereby enabling improved remediation of the software vulnerabilities. A machine learning (ML) method receives threat-intelligence information of the software vulnerabilities and generates a threat vector based on a security category and a data or schema category of the software vulnerability. The ML method can include a first portion constrained to predict a first intermediary result corresponding to the security category of the software vulnerability. The ML method can include a second portion constrained to predict a second intermediary result corresponding to the data or schema category of the software vulnerability.

### CROSS-REFERENCE TO RELATED APPLICATIONS

This application claims the benefit of priority to U.S. provisional application No. 63/493,552, filed on Mar. 31, 2023, which is expressly incorporated by reference herein in its entirety.

### BACKGROUND

The classification and triaging of software vulnerabilities is a largely manual process in the security industry. The number of security professionals with expertise to perform classification and triaging of vulnerabilities has not been able to keep up with the proliferation of vulnerabilities. Consequently, there is a need for more efficient methods for the classification and triaging of software vulnerabilities to make security professionals better able to fulfill the demand.

This challenge is encountered at multiple levels, including software vendors, internet service providers, computer network providers, hardware providers, etc. Currently, classification and triaging are performed by having an analyst generate a score that is used as the basis for the treatment of the vulnerability. The analyst bases the score on a combination of reviewing the threat intelligence (e.g., publicly available reports) and based on variables about the vulnerability that are derived from one or more scoring systems (e.g., a firm proprietary scoring system). This process can be inefficient and have limited accuracy, in part, because it can use publicly available information from the vulnerability disclosure.

In addition to the publicly available data in the vulnerability disclosure, there is also private data about vulnerabilities that can provide more detailed information about how the vulnerability can be exploited and the impact/scope of the vulnerability. Examples of this private/proprietary data about vulnerabilities are MANDIANT and TALOS threat intelligence data sets. This data can require significantly more effort to generate, and can therefore be maintained privately in order to monetize and recoup the cost of obtaining this information. Further, this private data can be maintained privately due to contract restrictions (e.g., it can be generated from research under a non-disclosure agreement).

This privately held threat data may not exist for every known common vulnerability and exposure, especially due to the large number of CVEs. For example, through the first three quarters of 2023, there are over 20,000 new CVEs received by the National Vulnerability Database (NVD) maintained by the National Institute of Standards and Technology (NIST). Further, the NVD contains nearly a quarter of a million total CVEs. More detailed analysis for these CVEs can require significant additional study and investigation by security professionals. For example, a more detailed analysis for these CVEs can be realized by detonating the CVE in a sandbox and gathering telemetry to understand the CVE's mode of operation and its impact/scope, which can be labor intensive.

The absence of good information regarding the method of exploitation and impact/scope of vulnerabilities limits their usefulness for extended detection and response (XDR), endpoint detection and response (EDR), and network detection and response (NDR). XDR is a cybersecurity technology that monitors and mitigates cybersecurity threats. Similarly, EDR and NDR are also cybersecurity technologies that monitor and mitigate cybersecurity threats. The difference among these three is largely due to the scope of telemetry data being monitored.

XDR, for example, works by collecting and correlating data across various network points such as servers, email, cloud workloads, and endpoints. The data is then analyzed and correlated, lending it visibility and context, and revealing advanced threats. Thereafter, the threats are prioritized, analyzed, and sorted to prevent security collapses and data loss. The XDR system helps organizations to have a higher level of cyber awareness, enabling cyber security teams to identify and eliminate security vulnerabilities.

One challenge is that security vulnerabilities are rarely used in XDR detections because security vulnerabilities are hard to relate to specific detections unless an intrusion detection system (IDS) signature exists. That is, it is difficult to correlate a specific vulnerability to a detection in the XDR space, unless there is an IDS signature that explicitly calls out that vulnerability or a malware reversal that explicitly calls out the exploit that is related to a vulnerability. Consequently, the vast majority of CVEs cannot be related to respective detections and do not provide useful information for an investigation. A missing piece that prevents security vulnerabilities from being useful in XDR investigations is the absence of threat information regarding the method of exploitation (e.g., the STRIDE classification or the MITRE ATT&CK technique or tactic classification) for the vulnerabilities.

Accordingly, improved methods are desired for predicting the method of exploitation and the impact/scope of vulnerabilities. And more particularly, methods are desired to automate or reduce the manual workload of one or more steps in predicting the method of exploitation and the impact/scope of vulnerabilities.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram for an example of a system/device for predicting threat vectors corresponding to vulnerabilities, in accordance with certain embodiments.

FIG. 2 illustrates a flow diagram for an example of a method of predicting threat vectors corresponding to vulnerabilities, in accordance with certain embodiments.

FIG. 3 illustrates a block diagram for database storing information related to methods of exploitation of vulnerabilities, in accordance with certain embodiments.

FIG. 4A illustrates a block diagram for an example of a transformer neural network architecture, in accordance with certain embodiments.

FIG. 4B illustrates a block diagram for an example of an encoder of the transformer neural network architecture, in accordance with certain embodiments.

FIG. 4C illustrates a block diagram for an example of a decoder of the transformer neural network architecture, in accordance with certain embodiments.

FIG. 5A illustrates a flow diagram for an example of a method of training a neural network, in accordance with certain embodiments.

FIG. 5B illustrates a flow diagram for an example of a method of using the trained neural network, in accordance with certain embodiments.

FIG. 6 illustrates a block diagram for an example of a computing device, in accordance with certain embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In one aspect, a method is provided for predicting an exploitation mechanism of a software vulnerability and/or for predicting an impact of the exploitation mechanism of the software vulnerability. The method includes obtaining threat-intelligence information regarding a software vulnerability. The method further includes applying the threat-intelligence information to a machine learning (ML) method to determine a threat vector based on a security category and a data or schema category of the software vulnerability. The threat vector comprises first indicia that represents a exploitation mechanism of the software vulnerability, and the threat vector comprises second indicia of a scope of the exploitation mechanism of the software vulnerability.

In another aspect, the method may also include that applying the threat-intelligence information to the ML method further comprises that the ML method including a first portion constrained to predict a first intermediary result corresponding to the security category of the software vulnerability and including a second portion constrained to predict a second intermediary result corresponding to the data or schema category of the software vulnerability, and the ML method predicting a threat vector for the software vulnerability based on the first intermediary result and the second intermediary result.

In another aspect, the method may also include that applying the threat-intelligence information to the ML method further comprises that the first portion of the ML method comprises a first transformer neural network that predicts, based on a security taxonomy or ontology, a type of security threat of the software vulnerability.

In another aspect, the method may also include that applying the threat-intelligence information to the ML method further comprises that the second portion of the ML method comprises a second transformer neural network that predicts, based on a data taxonomy or ontology, a type of data set or schema for the software vulnerability.

In another aspect, the method may also include that applying the threat-intelligence information to the ML method further comprises applying the threat-intelligence information to a classifier that classifies the software vulnerability according to the security category of the software vulnerability and according to the data or schema category of the software vulnerability.

In another aspect, the method may also include that the ML method has been trained using labeled training data that includes training threat-intelligence information that is labeled according to threat vectors, security categories, and data or schema categories.

In another aspect, the method may also include that the threat vector comprises the first indicia that is selected from the group consisting of a STRIDE threat category, a common vulnerability scoring system (CVSS) vector, a vulnerability type, the exploitation mechanism, an exploitation entry point, and MITRE ATT&CK framework tactics and techniques.

In another aspect, the method may also include providing the threat vector to a remediation processor; and performing, by the remediation processor, a remediating action based on the threat vector.

In another aspect, the method may also include that the remediating action is selected from the group consisting of quarantining a computer implementable instruction corresponding to the software vulnerability, installing a software patch, updating and/or upgrading software corresponding to the software vulnerability, defending privileges and/or accounts, enforcing signed software execution policies, exercising a recovery plan, managing systems and/or configurations, searching or scanning for network intrusions, engaging hardware security features, increasing segregation of networks and processors, and transitioning to multi-factor authentication.

In another aspect, the method may also include signaling the threat vector to a user; receiving user feedback regarding the values of the threat vector; and performing reinforcement learning based on the received user feedback to update the ML method (e.g., a prediction engine).

In another aspect, the method may also include, prior to receiving the user feedback, verifying, based on login credentials of the user, that the user is authorized to provide the user feedback.

In one aspect, a computing apparatus includes a processor. The computing apparatus also includes a memory storing instructions that, when executed by the processor, configure the apparatus to perform the respective steps of any one of the aspects of the above-recited methods.

In one aspect, a computing apparatus includes a processor. The computing apparatus also includes a memory storing instructions that, when executed by the processor, configure the apparatus to obtain threat-intelligence information regarding a software vulnerability; and apply the threat-intelligence information to a machine learning (ML) method to determine a threat vector based on a security category and a data or schema category of the software vulnerability, wherein the threat vector comprises first indicia that represents a exploitation mechanism of the software vulnerability, and the threat vector comprises second indicia that represents a scope of the exploitation mechanism of the software vulnerability.

In another aspect of the computing apparatus, when executed by the processor, instructions stored in the memory cause the processor to apply the threat-intelligence information to the ML method such that: the ML method includes a first portion constrained to predict a first intermediary result corresponding to the security category of the software vulnerability, the ML method includes a second portion constrained to predict a second intermediary result corresponding to the data or schema category of the software vulnerability, and the ML method is configured to predict a threat vector for the software vulnerability based on the first intermediary result and the second intermediary result.

In another aspect of the computing apparatus, when executed by the processor, instructions stored in the memory cause the processor to apply the threat-intelligence information to the ML method such that the first portion of the ML method comprises a first transformer neural network that predicts, based on a security taxonomy or ontology, a type of security threat of the software vulnerability.

In another aspect of the computing apparatus, when executed by the processor, instructions stored in the memory cause the processor to apply the threat-intelligence information to the ML method such that the second portion of the ML method comprises a second transformer neural network that predicts, based on a data taxonomy or ontology, a type of data set or schema for the software vulnerability.

In another aspect of the computing apparatus, when executed by the processor, instructions stored in the memory cause the processor to apply the threat-intelligence information to the ML method by applying the threat-intelligence information to a classifier that classifies the software vulnerability according to the security category of the software vulnerability and according to the data or schema category of the software vulnerability.

In another aspect of the computing apparatus, the ML method has been trained using labeled training data that includes training threat-intelligence information that is labeled according to threat vectors, security categories, and data or schema categories.

In another aspect of the computing apparatus, the threat vector comprises the first indicia that is selected from the group consisting of a STRIDE threat category, a common vulnerability scoring system (CVSS) vector, a vulnerability type, the exploitation mechanism, an exploitation entry point, and MITRE ATT&CK framework tactics and techniques.

In another aspect of the computing apparatus, when executed by the processor, instructions stored in the memory cause the processor to provide the threat vector to a remediation processor; and perform, by the remediation processor, a remediating action based on the threat vector.

In another aspect of the computing apparatus, the remediating action is selected from the group consisting of quarantining a computer implementable instruction corresponding to the software vulnerability, installing a software patch, updating and/or upgrading software corresponding to the software vulnerability, defending privileges and/or accounts, enforcing signed software execution policies, exercising a recovery plan, managing systems and/or configurations, searching or scanning for network intrusions, engaging hardware security features, increasing segregation of networks and processors, and transitioning to multi-factor authentication.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art to relate software vulnerabilities to their method of exploitation and impact/scope. More particularly, the systems and methods disclosed herein predict a threat vector based on available threat intelligence for a given vulnerability. The threat vector can include information regarding the method of exploitation and impact/scope of the vulnerability, and this information can be used, e.g., in response to a security attack to determine which vulnerability is being targeted by the attack and what remediating actions should be taken.

Software vulnerabilities are weaknesses or flaws in computational logic. When exploited, a vulnerability can be used in various malicious manners, including, e.g., facilitating unauthorized access to a computing device, enabling an attack to remain undetected, permitting unauthorized modification of data, or reducing the availability of data. An attempt to exploit or take advantage of a vulnerability is an attack, and a successful attack results in a breach.

Often, software programs are developed to exploit vulnerabilities. Herein, such software programs are referred to as “exploits.” Vulnerabilities can be fixed using patches or version upgrades, for example. Vulnerabilities for which exploits are developed and used in attacks can be written up and published by a CVE numbering authority (CNA) as a common vulnerability and exposure (CVE). Often, however, the CVE is not used when a cyber attack is detected (e.g., an XDR detection) unless an intrusion detection system (IDS) signature exists. The systems and methods disclosed herein address this deficiency by predicting threat vectors based on the available threat intelligence for a given vulnerability.

Extended detection and response (XDR) is a cybersecurity technology that monitors and mitigates cybersecurity threats. Similarly, endpoint detection and response (EDR) and network detection and response (NDR) are also cybersecurity technologies that monitor and mitigate cybersecurity threats. The difference among these three is largely due to the scope of telemetry data being monitored.

XDR, for example, works by collecting and correlating data across various network points such as servers, email, cloud workloads, and endpoints. The data is then analyzed and correlated, lending it visibility and context, and revealing advanced threats. Thereafter, the threats are prioritized, analyzed, and sorted to prevent security collapses and data loss. The XDR system helps organizations to have a higher level of cyber awareness, enabling cyber security teams to identify and eliminate security vulnerabilities.

One challenge is that security vulnerabilities are rarely used in XDR detections because security vulnerabilities are hard to relate to specific detections unless an intrusion detection system (IDS) signature exists. That is, it is difficult to correlate a specific vulnerability to a detection in the XDR space, unless there is an IDS signature that explicitly calls out that vulnerability or a malware reversal that explicitly calls out the exploit that is related to a vulnerability. Consequently, significantly less than half of the CVEs can be related to respective detections and do not provide useful information for an investigation. A missing piece that prevents security vulnerabilities from being useful in XDR investigations is the absence of information regarding the method of exploitation and the impact/scope of the vulnerabilities. Examples of such information can be found, at least partially, in the MITRE ATT&CK technique and tactic classifications, the STRIDE threat classifications, the common vulnerability scoring system (CVSS), for example.

According to certain non-limiting examples, the systems and methods disclosed herein provide the above-noted missing piece by using ML method (e.g., a prediction engine) to predict a threat vector for a given vulnerability based on the available threat intelligence for said vulnerability. The threat vector can include classifications with respect to the methods of exploitation, the impact/scope of the vulnerability, the method by which an attack works, the impact if the attack is successful, and what is the classification of technique or tactic that an attacker uses by employing that method of exploitation.

According to certain non-limiting examples, The systems and methods disclosed herein can provide a top level of clustering of the vulnerabilities. This is an improvement over the current state in the industry, which is that this information needs to be manually assigned in investigations. Even if the systems and methods disclosed herein are only partially effective at predicting the threat vectors for CVEs (e.g., only provide threat vectors for 50% of CVEs), this partial result is still beneficial because it greatly reduces the number of CVEs which must be determined manually, which can be very time consuming. Once the above-noted threat vectors are assigned to the CVEs, the threat vectors make the investigations of attack detections much easier because the threat vectors enable automatically pulling the vulnerability scan.

The systems and methods disclosed herein can use various threat intelligence to predict the threat vectors. For example, the threat intelligence can include source code of the vulnerability, assemble code of the exploits, reverse engineering notes/comments regarding the code of the exploits; indicators of compromise (IoC); indicators of Attack (IoA); published CVEs, security related blogs, reports, whitepapers, etc.; various types of telemetry data from attacks; and the like.

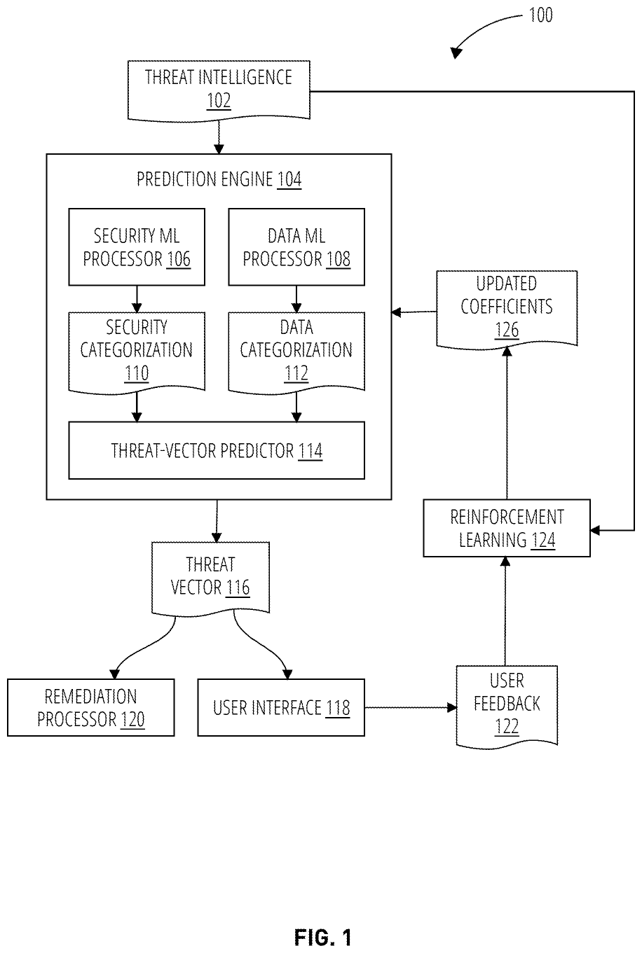

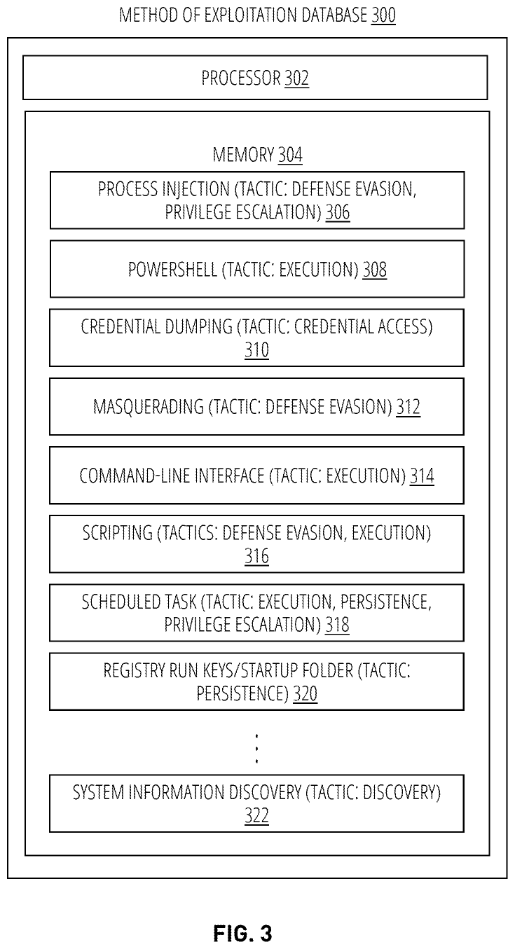

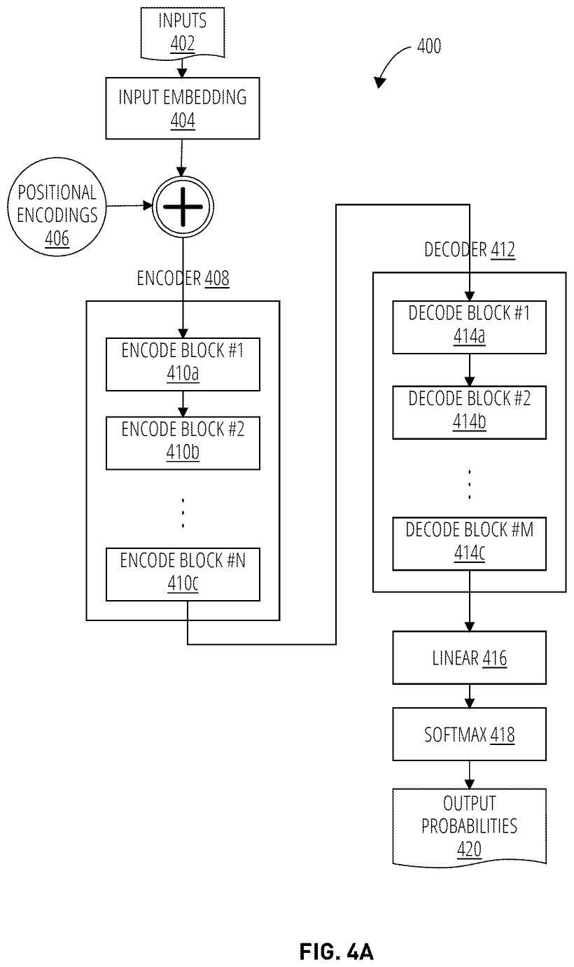

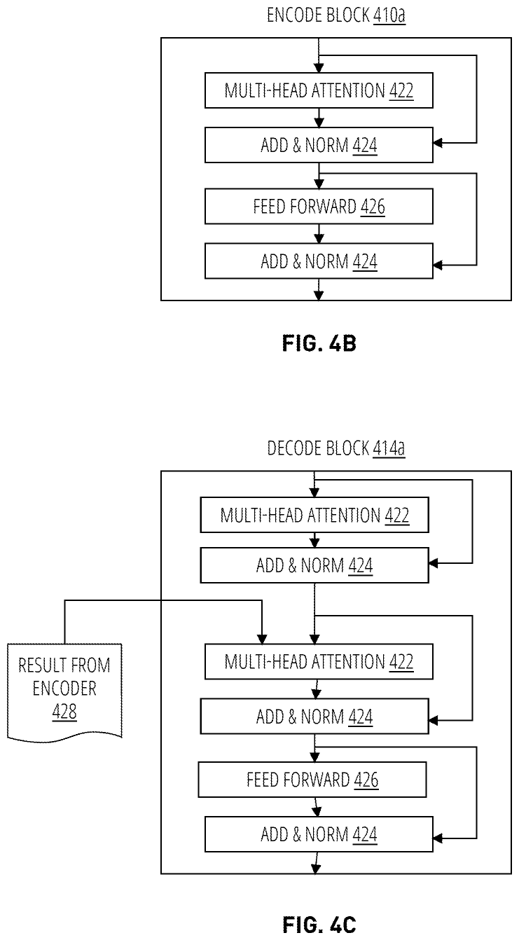

The threat vector prediction system 100 shown in FIG. 1 includes a prediction engine 104 that receives data describing a vulnerability (e.g., the threat intelligence 102). The prediction engine 104 can include one or more machine learning (ML) methods. According to certain non-limiting examples, as is illustrated in FIG. 1, the prediction engine 104 can have respective parts/portions, including, e.g., a security ML processor 106, a data ML processor 108. and a threat-vector predictor 114. The prediction engine 104 generates the threat vector 116 based on threat intelligence 102. Aspects of the prediction engine 104 and the ML methods used therein are described below with reference to the method of exploitation database 300 illustrated in FIG. 3 and the transformer architecture 400 illustrated in FIG. 4A through FIG. 4C.

The threat vector 116 from the prediction engine 104 can be used in two ways: (i) the it can be communicated via a UI 118 to a user and (ii) it can be used in the remediation processor 120 to guide which remediating actions are to be taken.

The threat vector prediction system 100 includes a UI 118 that can display the threat vector 116 to a user and can receive User feedback 122 from the user. For example, the user can confirm the correctness of the predicted threat vector 116, or the user can provide corrections to the threat vector 116. According to certain non-limiting examples, the UI 118 can also display results from the security categorization 110 and/or the data categorization 112 to also receive feedback regarding these predictions. The feedback can include indications of false positives, false negatives, true positives, and true negatives. The feedback can include indications of when the results were ambiguous or omitted significant information.

The User feedback 122 can then be combined with the threat intelligence 102 as new training data to be used in reinforcement learning 124 to generate updated coefficients 126 for the ML methods in the prediction engine 104.

Generally, the threat intelligence 102 can include publicly available information regarding a vulnerability, such as a CVE description, vulnerability reports, and, when available, publicly available scores from service providers (e.g., scores for managed security service providers (MSSPs), such as the exploit prediction scoring system (EPSS). Additionally or alternatively, the threat intelligence 102 can include telemetry of one or more attacks on the vulnerability and source code or assembly code (e.g., source code of for the vulnerability and assembly code of the exploit from the one or more attacks).

The publicly vulnerability data typically omits significant variables that are insightful for predicting the method of exploitation and impact/scope of the vulnerability. At least, these significant variables are not explicitly recited in the public threat intelligence, but, latent information in the public threat intelligence may be sufficient to reliably predict these significant variables.

A general large language model (LLM) tasked with predicting threat vectors 116 will perform suboptimally because of nuances and ambiguities regarding how terms are used in a cybersecurity context. Thus, the LLM should be constrained through specific training and/or imposed through the structure of the LLM to generate meaningful result in the specific context of cybersecurity.

For example, an LLM may be able to predict that a vulnerability is susceptible to a buffer overflow attack, but this prediction by itself is of limited usefulness without also knowing the data categorization (e.g., the schema and data sets) corresponding to the vulnerability. Consider that, Many different buffer overflow attacks use different strategies and target different pieces of code. In a stack overflow attack the buffer overflows in the call stack. In a heap overflow attack, the attack targets data in the open memory pool known as the heap. An integer overflow attack occurs when an arithmetic operation results in an integer that is too large to store the integer type, potentially resulting in a buffer overflow. In a unicode overflow, the buffer overflow is created by inserting Unicode characters into the expected input of ASCII characters.

Further, the susceptibility to overflow attacks and the method of exploitation thereof can vary depending on programming language. Buffer overflow attacks can be caused by coding errors and mistakes in application development, resulting in buffer overflow due to the application failing to allocate appropriately sized buffers and failing to check for overflow issues. Buffer overflow attacks can be particularly problematic in the programming languages C and C++ because they lack built-in buffer overflow protection. This programming language is not the only one vulnerable to buffer overflow attacks. Additionally, applications written in Assembly or Fortran are also vulnerable and more likely to enable attackers to compromise a system. In contrast, applications written in JavaScript or Perl are typically less vulnerable to buffer overflow attacks.

Similarly, a general LLM may generate unhelpful results because it is not able to differentiate between different methods of exploitation. For example, a general LLM may generate a lot of false positives because different methods of exploitation are often described in close proximity within a vulnerability advisor. Thus, a general LLM might take this proximity as a correlation and determine that different methods of exploitation are the same method of exploitation, but they are not. Consider an advisory including six vulnerabilities, and that each of these vulnerabilities does a different method of exploitation. If a general LLM were asked to summarize this advisory, it may tell you that this vulnerability is a heap corruption and a buffer overflow into remote code execution, but that is actually describing three vulnerabilities. Thus, to avoid this conflation of different vulnerabilities and different methods of exploitation, the prediction engine 104 can include a portion directed to data taxonomy.

FIG. 1 illustrates a certain non-limiting example of an architecture that constrains/guides the prediction engine 104 to generate results that are meaningful in the context of cybersecurity. Here, the prediction engine 104 is structured with a security ML processor 106 and a data ML processor 108 that respectively generate intermediary results of security categorization 110 and data categorization 112. The security ML processor 106 “speaks” the language of cybersecurity. For example, this can be a result of the security ML processor 106 having been trained using training data that is specifically curated for cybersecurity. Alternatively or additionally, the security ML processor 106 can be guided by using a cybersecurity ontology or taxonomy to guide/constrain its results. The security categorization 110 can be values/probabilities that are informed by the classes, rules, and relationships defined in a cybersecurity ontology, taxonomy, or schema.

A cybersecurity ontology expresses concepts and relationships that have common, unambiguous, and unique definitions that are agreed on in the shared range. Thus, when using the cybersecurity ontology to constrain a transformer neural network, the transformer neural network is guided to express the information concepts from the threat intelligence 102 in the categories/types within the range defined by the cybersecurity ontology to extract the relevant information for cybersecurity. Thus, even though different formats are used for log files from disparate sources, the cybersecurity ontology can ensure consistency between the categories of entities and relationships to which the log files are mapped.

Generally, a cybersecurity ontology (and similarly for a taxonomy or schema) is used to describe cybersecurity concepts and relationships between concepts in a cybersecurity field or even a wider range. These concepts and relationships have a common, unambiguous, and unique definition that is agreed on in the shared range. For example, the Unified Cybersecurity Ontology (UCO) model integrates several existing knowledge schemas and standards into a common model for the cybersecurity domain by integrating heterogeneous data and knowledge schemas from various cybersecurity systems, as well as the most commonly used cybersecurity standards for information sharing and exchange.

The data ML processor 108 “speaks” the language of data types and schemas. For example, this can be a result of the data ML processor 108 having been trained using training data that is specifically curated to represent and distinguish among data types and schemas. Alternatively or additionally, the security ML processor 106 can be guided by using a data ontology or taxonomy to guide/constrain its results. The data categorizations 112 can be values/probabilities that are informed by the classes, rules, and relationships defined in a data ontology or taxonomy.

The security ML processor 106 and data ML processor 108 can be two transformer networks or can be different parts of the same neural network. According to the non-limiting example illustrated in FIG. 1, the security ML processor 106 and data ML processor 108 can be two transformers operating in parallel. These can be two types of transformers: (i) a semantic transformer for the security ML processor 106 and (ii) a data transformer for the data ML processor 108. That is, the security ML processor 106 can be a semantic transformer that is conditioned to express information in the language of security (i.e., draw the types of conclusion and look for patterns relevant to a security analyst). For example, the security ML processor 106 determines the semantic meaning of the threat intelligence 102 from a security analyst's perspective. Similarly, the data ML processor 108 can be a data transformer that is conditioned to express information in terms of relationships between the schemas and the data sets. This layered approach provides improved accuracy and detailed analysis compared to a simpler approach in which an LLM is simply asked to summarize the method of exploitation based on a collection of text about the vulnerability.

Returning to FIG. 1, the UI 118 can include the functionality of receiving login credentials from the user, and different users can have different permissions regarding their ability to view the threat vectors and provide User feedback 122. For example, the User feedback 122 should preferably come from security experts to ensure the results do not become corrupted by bad feedback. Thus, based on the user's credentials and indicia of their level of expertise, the UI 118 could refuse feedback provided by a non-expert. Alternatively or additionally, the feedback could be weighted based on the level of expertise of the user.

Initially, the prediction engine 104 can be trained using training data. This training can be performed using either supervised or unsupervised learning.

For example, private threat intelligence exist at a very high level for many well-studied CVEs. Based on this private threat intelligence, the threat vectors are already known (or can be easily derived) for the well-studied CVEs. Public threat intelligence also exists for the well-studied CVEs. Thus, for supervised learning, the prediction engine 104 can be trained using labeled training data in which the public threat intelligence is the input to the neural network and the threat vector based on the private threat intelligence is the gold standard that is used as the label. Thus, the prediction engine 104 uses the public threat intelligence to generate threat vectors, which are then compared to the labels (i.e., the threat vectors from the private threat intelligence.

For unsupervised learning, the prediction engine 104 can be trained on a large corpus of reports about vulnerabilities, and this corpus can include both public threat intelligence and private threat intelligence. Generally, the private threat intelligence can be more voluminous and detailed. Thus, the prediction engine 104 can be trained using only the private threat intelligence to learn the reasoning and patterns therein. Then, the prediction engine 104 can be applied to new (or old) public threat intelligence of poorly-studied vulnerabilities for which private threat intelligence does not exist or is sparse/limited, such that threat vectors are not known. The prediction engine 104, then predicts threat vectors for these poorly-studied vulnerabilities.

Generally, a threat vector includes indicia of the method of exploitation and impact/scope of a vulnerability. For example, the threat vector can include a STRIDE threat classification, which can be used to identify various types of threats an application is susceptible to such that measures can be taken to close these security gaps. The STRIDE threat classification can include indicia with respect to: (i) spoofing of user identity; (ii) tampering with data; (iii) repudiability; (iv) information disclosure (e.g., privacy breach); (v) denial of Service (DOS); and escalation of privilege. As a first example of generating the threat vector based on a STRIDE threat classification, the threat vector can include a tag to “escalation of privileges” based on the following public threat intelligence: “the vulnerability is a flaw that allowed an attacker to corrupt memory and possibly escalate privileges; the vulnerability was found In the mwiflex kernel module while connecting to a malicious wireless network.” As a second example of generating the threat vector based on a STRIDE threat classification, the threat vector can include tags to “DoS” and “information disclosure” based on the following public threat intelligence: “the vulnerability is a flaw was found in the HDLC PPP module of the Linux kernel in versions before 5.9-rc7; memory corruption and a read overflow is caused by improper input validation in the ppp_cp_parse_cr function which can cause the system to crash or cause a denial of service; the highest threat from this vulnerability is to data confidentiality and integrity as well as system availability.”

Further, the threat vector can include indicia of the vulnerability type. For example, the vulnerability type can be extracted as a tag and provided as part of the threat vector. Examples of vulnerability types can include: (i) use-after-free, (ii) buffer overflow, (iii) out of bounds write, (iv) out of bounds read, etc. As an example of generating the threat vector based on a STRIDE threat classification, the threat vector can include tags of “Out of bounds read” and “Out of bounds write” based on the following public threat intelligence: “Out of bounds read and write in PDAum in Google Chrome prior to 81.0.4044.122 allowed a remote attacker to potentially exploit heap corruption via a crafted PDF file. (tags: Out of bounds read, Out of bounds write.”

Additionally, the threat vector can include indicia of the exploitation methodology. For example, the exploitation methodology can be extracted as a tag and provided as part of the threat vector. Examples of exploitation methodologies can include: heap corruption, out of bounds memory access, bypass navigation restrictions, sandbox escape. As an example of generating the threat vector based on a STRIDE threat classification, the threat vector can include a tag of “heap corruption” based on the following public threat intelligence: “use after free in WebRTC in Google Chrome prior to 86.0.4240.75 allowed a remote attacker to potentially exploit heap corruption via a crafted WebRTC stream.”

Moreover, the threat vector can include indicia of the exploitation entry point. For example, the exploitation entry point can be extracted as a tag and provided as part of the threat vector. As a first example of the exploitation entry point, the threat vector can include a tag to “file” based on the following public threat intelligence: “uninitialized data in PDFium in Google Chrome prior to 89.0.4389.72 allowed a remote attacker to obtain potentially sensitive information from process memory rob a crafted PDF.” As a second example of the exploitation entry point, the threat vector can include a tag to “via a crafted HTML page” based on the following public threat intelligence: “use after free in Blink in Google Chrome prior to 84.0.4147.125 allowed a remote attacker to potentially exploit heap corruption.”

The threat vector can also include other indicia of the type of vulnerability, method of exploitation, and impact/scope, including, e.g., the common vulnerability scoring system (CVSS) and the MITRE ATT&CK framework, which as discussed below with reference to FIG. 3.

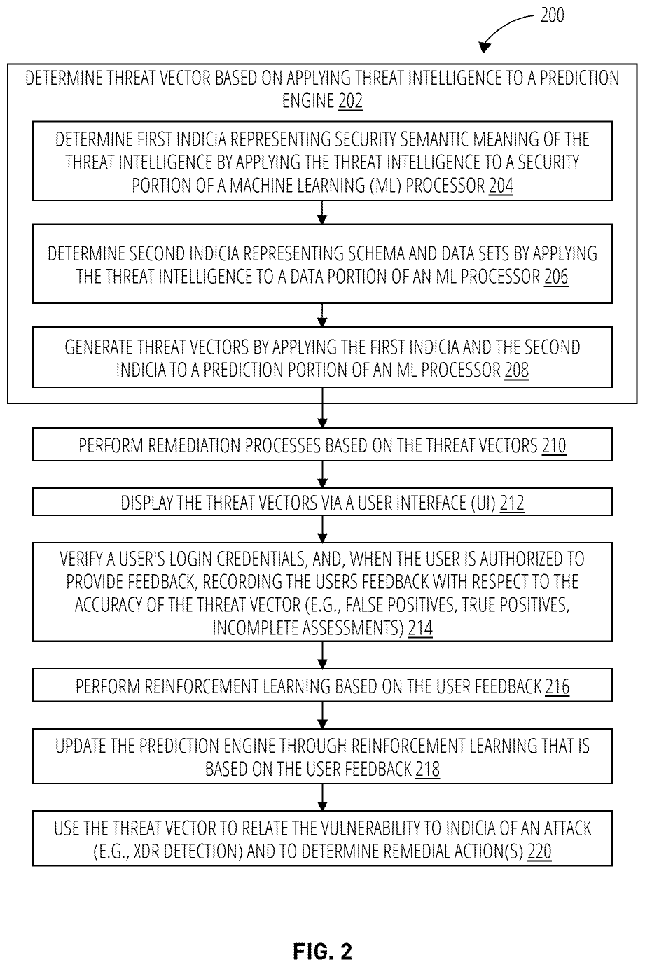

FIG. 2 illustrates an example prediction method 200 for predicting which vulnerabilities will have exploits developed for and which vulnerabilities will be attacked using said exploits. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

FIG. 2 illustrates an example prediction method 200 for predicting threat vectors (e.g., methods of exploitation and impact/scope of vulnerabilities) based on threat intelligence and using the threat vectors to guide responses to detections of cybersecurity attacks (e.g., XDR detections). Although the example prediction method 200 depicts a particular sequence of operations, the sequence may be altered without departing from the scope of the present disclosure. For example, some of the operations depicted may be performed in parallel or in a different sequence that does not materially affect the function of the prediction method 200. In other examples, different components of an example device or system that implements the prediction method 200 may perform functions at substantially the same time or in a specific sequence.

According to some examples, in process 202, a threat vector 116 can be determined based on applying threat intelligence 102 to a prediction engine 104. According to certain non-limiting examples, process 202 can include steps 204 through 208.

According to some examples, at step 204, process 202 includes determining a first set of indicia, which represent the security semantic meaning of the threat intelligence 102. According to certain non-limiting examples, the first indicia are determined by applying the threat intelligence 102 to a security portion of a machine learning (ML) processor. For example, this can be performed by the security ML processor 106 and can be performed in accordance with the disclosure referencing FIG. 1.

According to some examples, at step 206, process 202 includes determining a second set of indicia, which represent information regarding the schema and data sets of a vulnerability. According to certain non-limiting examples, the second indicia are determined b by applying the threat intelligence to a data portion of the ML processor. For example, this can be performed by the data ML processor 108, and can be performed in accordance with the disclosure referencing FIG. 1.

According to some examples, in step 208, process 202 includes generating threat vectors by applying the first indicia and the second indicia to a prediction portion of the ML processor. For example, this can be performed by the threat-vector predictor 114, and can be performed in accordance with the disclosure referencing FIG. 1.

According to some examples, at step 210, the method includes performing remediation processes based on the threat vectors 116. This can be performed by the remediation processor 120, and can be performed in accordance with the disclosure referencing FIG. 1.

According to some examples, in step 212, the threat vectors can be displayed via a user interface (UI) 118, as disclosed above with reference to FIG. 1.

According to some examples, in step 214, the method includes verifying a user's login credentials. When the user is recognized as being authorized to provide feedback, UI 118 can receive user feedback 122 indicating the accuracy of the threat vector (e.g., false positives, true positives, incomplete assessments), as disclosed above with reference to FIG. 1.

According to some examples, the method includes performing reinforcement learning based on the user feedback at step 216, as disclosed above with reference to FIG. 1.

According to some examples, in step 218, the prediction engine 104 is updated via reinforcement learning that is based on the user feedback 122, as disclosed above with reference to FIG. 1.

According to some examples, in step 220, the threat vector 116 can be used to relate the vulnerability to indicia of an attack (e.g., XDR detection) and to determine remedial action(s), as disclosed above with reference to FIG. 1. For example, this step can be performed using the remediation processor 120, or the results from the remediation processor 120 can be stored and then later recalled such that this step can be performed based on results from the remediation processor 120 but be performed by another processor which is independent of the remediation processor 120.

As discussed above with reference to FIG. 1, the threat vector can include various tags that are predicted based on similarities between a current vulnerability to historical vulnerabilities, and this similarity can be determined based on the similarities between the threat intelligence 102 of the current vulnerability to the historical threat intelligence corresponding to each of the historical vulnerabilities. That is, the prediction engine 104 learns the latent patterns and information in the historical threat intelligence that correlates with particular types of threat vectors corresponding to the respective types of historical vulnerabilities. Then based on which of these learned patterns the threat intelligence 102 of the current vulnerability most closely matches, the prediction engine 104 can predict probabilities for the categories in the threat vector 116. As discussed above, According to certain non-limiting examples, the threat vector can include an array of values or tags corresponding to respective categories. These categories can include STRIDE threat classifications, vulnerability types, exploitation methodologies, exploitation entry points, CVSS vectors, MITRE ATT&CK tactics and techniques.

When, the threat vector includes an array of values corresponding to respective categories, each position in the array can correspond to a particular category (e.g., position “1” can story a probability that the current vulnerability falls into the category of process injection with tactics defense evasion, privilege escalation). According to certain non-limiting examples, the values can be predicted probabilities or values derived from predicted probabilities. For example, the values in the threat vector can be binary which are “1” when a given probability is greater than a predefined threshold and are “0” otherwise. Alternatively or additionally, a predefined number of values in the threat vector that have the highest percentage can be assigned a value of “1” and all other values in the threat vector can be assigned a value of “0”.

Some of the positions in the threat vector 116 can be assigned values corresponding to categories in a method of exploitation database 300, as illustrated in FIG. 3. Additionally, some of the positions in the threat vector 116 can be assigned values corresponding to categories in the impact/scope of exploitation database. FIG. 3 illustrates a non-limiting example of the method of exploitation database 300 being based on the MITRE ATT&CK framework. According to certain non-limiting examples, the method of exploitation database 300 can include categories corresponding to the STRIDE threat classifications, vulnerability types, exploitation methodologies, exploitation entry points, CVSS vectors, MITRE ATT&CK tactics and techniques, or any combination thereof. As would be understood by a person of ordinary skill in the art, these examples of categories for the threat vector 116 are non-limiting, and other categories can be used for the threat vector 116.

The method of exploitation database 300 includes a processor 302, a memory 304. The memory includes several attack modes (also referred to as methods of exploitation) for vulnerabilities and associated information regarding the attack modes, such as the tactics, techniques, and procedures applicable to each of the given vulnerabilities. In the non-limiting example shown in FIG. 3, the attack modes include process injection 306, powershell 308, credential dumping 310, masquerading 312, command-line interface 314, scripting 316, scheduled task 318, registry run keys/startup folder 322, and system information discovery 322. For example, the prediction engine 104 can generate probabilities that a given vulnerability is within one (or more) of these classifications.

In certain non-limiting examples, the attack modes can use the MITRE ATT&CK framework (e.g., 14 tactics, 185 techniques, 367 sub-techniques). For example, the known combinations of tactics and techniques can make up a tokenized vocabulary, and one or more of the ML methods in the prediction engine 104 can be a transformer neural network that can transform the description of the vulnerability in the threat intelligence 102 the tokenized vocabulary of the MITRE ATT&CK framework. This translation can be based on similarities between the given threat intelligence 102 and historical threat intelligence for historical vulnerabilities that were in the training data that was used to train the transformer neural network.

Additionally or alternatively, the attack modes/methods of exploitation can correspond to various metrics applied for common vulnerability scoring system (CVSS), including: (i) an access vector (e.g., the way in which a vulnerability can be exploited); (ii) attack complexity (e.g., how difficult a vulnerability is to exploit); (iii) authentication (e.g., how many times an attacker has to use authentication credentials to exploit the vulnerability); (iv) confidentiality (e.g., how much sensitive data an attacker can access after exploiting the vulnerability); (v) integrity (e.g., how much and how many files can be modified as a result of exploiting the vulnerability); and (vi) availability (e.g., how much damage exploiting the vulnerability does to the target system).

Additionally or alternatively, one or more of the ML methods in the prediction engine 104 can include a clustering method. A transformer neural network or natural language processing method can map the unstructured data to a multi-dimensional space representative of different aspects/dimensions of the vulnerability (e.g., the security categorization 110 and data categorization 112). This mapping from the methods of exploitation of the vulnerability to the multi-dimensional space can be a learned mapping. When the historical threat intelligence corresponding to the historical vulnerabilities is mapped to the multi-dimensional space, then a clustering method (e.g., such as k-means clustering) can be applied within the multi-dimensional space to group/divide different regions according to the attack classifications. The learned mapping provides the optimal clustering. When the threat intelligence 102 for a given vulnerability is mapped to a given location of the multi-dimensional space, then the probability corresponding to classifications can be related to in inverse of a distance measure (e.g., the Euclidean distance) with some normalization.

The threat vector 116 can include additional information to guide the cyber security professional. The additional information can include a mean and a standard deviation for a time period from when a vulnerability is reported until when an exploit is developed or when an attack first occurs. The additional information can include guidance on the probabilities of respective tactics, techniques, and procedures being applicable for a given vulnerability. The additional information can include guidance on the probabilities of certain values of the CVSS being applicable for a given vulnerability (e.g., the access vector, attack complexity, etc.).

The transformer architecture 400, which is illustrated in FIGS. 4A-4C, includes inputs 402, an input embedding block 404, positional encodings 406, an encoder 408 (e.g., encode blocks 410a, 410b, and 410c), a decoder 412 (e.g., decode blocks 414a, 414b, and 414c), a linear block 416, a softmax block 418, and an output probabilities 420.

The inputs 402 can include threat intelligence 102 conveying information about a vulnerability. The transformer architecture 400 is used to determine output probabilities 420 regarding the vulnerability, including, e.g., the method of exploitation and impact/scope of the vulnerability

The input embedding block 404 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 404 can be learned embeddings to convert the input tokens and output tokens to vectors that have the same dimension as the positional encodings, for example.

The positional encodings 406 provide information about the relative or absolute position of the tokens in the sequence. According to certain non-limiting examples, the positional encodings 406 can be provided by adding positional encodings to the input embeddings at the inputs to the encoder 408 and decoder 412. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that so doing allows the model to extrapolate to sequence lengths longer than the ones encountered during training.

The encoder 408 uses stacked self-attention and point-wise, fully connected layers. The encoder 408 can be a stack of N identical layers (e.g., N=6), and each layer is an encode block 410, as illustrated by encode block 410a shown in FIG. 4B. Each encode block 410 has two sub-layers: (i) a first sub-layer has a multi-head attention block 422 and (ii) a second sub-layer has a feed forward block 426, which can be a position-wise fully connected feed-forward network. The feed forward block 426 can use a rectified linear unit (ReLU).

The encoder 408 uses a residual connection around each of the two sub-layers, followed by an add & norm block 424, which performs normalization (e.g., the output of each sub-layer is LayerNorm(x+Sublayer(x)), i.e., the product of a layer normalization “LayerNorm” time the sum of the input “x” and output “Sublayer(x)” pf the sublayer LayerNorm(x+Sublayer(x)), where Sublayer(x) is the function implemented by the sub-layer). To facilitate these residual connections, all sub-layers in the model, as well as the embedding layers, produce output data having a same dimension.

Similar to the encoder 408, the decoder 412 uses stacked self-attention and point-wise, fully connected layers. The decoder 412 can also be a stack of M identical layers (e.g., M=6), and each layer is a decode block 414, as illustrated by encode decode block 414a shown in FIG. 4C. In addition to the two sub-layers (i.e., the sublayer with the multi-head attention block 422 and the sub-layer with the feed forward block 426) found in the encode block 410a, the decode block 414a can include a third sub-layer, which performs multi-head attention over the output of the encoder stack. Similar to the encoder 408, the decoder 412 uses residual connections around each of the sub-layers, followed by layer normalization. Additionally, the sub-layer with the multi-head attention block 422 can be modified in the decoder stack to prevent positions from attending to subsequent positions. This masking, combined with fact that the output embeddings are offset by one position, ensures that the predictions for position i can depend only on the known output data at positions less than i.

The linear block 416 can be a learned linear transfor-mation. For example, when the transformer architecture 400 is being used to translate from a first language into a second language, the linear block 416 projects the output from the last decode block 414c into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

The softmax block 418 then turns the scores from the linear block 416 into output probabilities 420 (which add up to 1.0). In each position, the index provides for the word with the highest probability, and then map that index to the corresponding word in the vocabulary. Those words then form the output sequence of the transformer architecture 400. The softmax operation is applied to the output from the linear block 416 to convert the raw numbers into the output probabilities 420 (e.g., token probabilities).

Although the above example uses the case of translating from the first language to the second language to illustrate the functions of the transformer architecture 400, the output probabilities 420 can be other entities, such as probabilities for the threat vector 116, including, e.g., methods of exploitation and impact/scope of the vulnerability. Further, the predicted output probabilities 420 can relate to the attack mode/classification (e.g., using the MITRE ATT&CK framework). The transformer architecture 400 can generate output probabilities 420 related to the tactics, techniques, and procedures applicable to the vulnerability. Additionally or alternatively, the transformer architecture 400 can generate output probabilities 420 related to predictions for the metrics applied for common vulnerability scoring system (CVSS), including, e.g. an access vector (e.g., the way in which a vulnerability can be exploited); attack complexity (e.g., how difficult a vulnerability is to exploit); authentication (e.g., how many times an attacker has to use authentication credentials to exploit the vulnerability); confidentiality (e.g., how much sensitive data an attacker can access after exploiting the vulnerability); integrity (e.g., how much and how many files can be modified as a result of exploiting the vulnerability); and availability (e.g., how much damage exploiting the vulnerability does to the target system).

Generally, the transformer architecture 400 can generate output probabilities 420 related to the threat vector 116 that can be used to guide cybersecurity professionals regarding how the vulnerability operates, its impact/scope, and how it might be remediated.

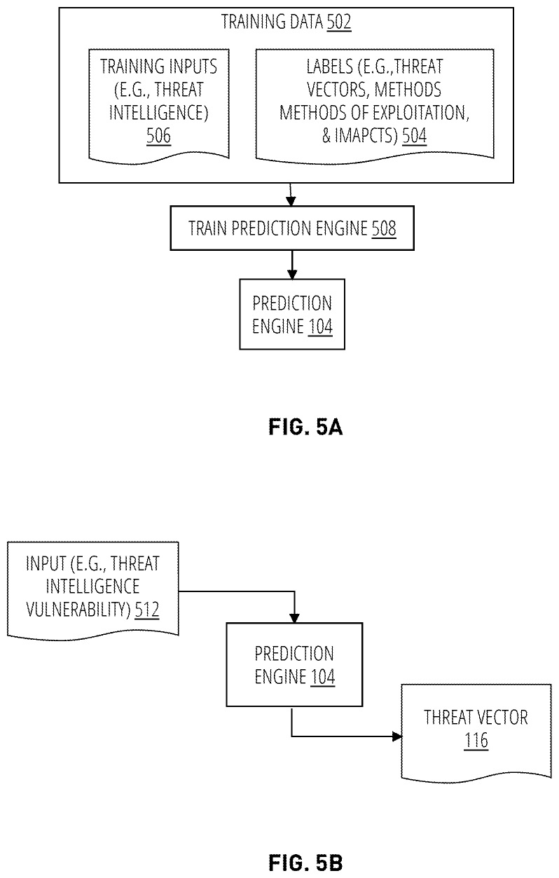

FIG. 5A illustrates an example of training a prediction engine 104. The same training methods disclosed herein can be applied to training parts of the prediction engine 104, such as the security ML processor 106, the data ML processor 108, and threat-vector predictor 114. In step 508, training data 502, which includes the labels 504 and the training inputs 506) is applied to train the prediction engine 104. For example, the prediction engine 104 can be an artificial neural network (ANN) that is trained via supervised or unsupervised learning using a backpropagation technique to train the weighting parameters between nodes within respective layers of the ANN.

In supervised learning, the training data 502 is applied as an input to the prediction engine 104, and an error/loss function is generated by comparing the output from the prediction engine 104 with the labels 504 (e.g., User feedback 122, which can include user-supplied values/corrections for the threat vector 116). The coefficients of the prediction engine 104 are iteratively updated to reduce an error/loss function. The value of the error/loss function decreases as outputs from the prediction engine 104 increasingly approximate the labels 504. In other words, ANN infers the mapping implied by the training data, and the error/loss function produces an error value related to the mismatch between the labels 504 and the outputs from the prediction engine 104 that are produced as a result of applying the training inputs 506 to the prediction engine 104.

Alternatively, for unsupervised learning or semi-supervised learning, training data 502 is applied to train the prediction engine 104. For example, the prediction engine 104 can be an artificial neural network (ANN) that is trained via unsupervised or self-supervised learning using a backpropagation technique to train the weighting parameters between nodes within respective layers of the ANN.

The advantage of the transformer architecture 400 is that it can be trained through self-supervised learning or unsupervised methods. The Bidirectional Encoder Representations from Transformer (BERT), for example, does much of its training by taking large corpora of unlabeled text, masking parts of it, and trying to predict the missing parts. It then tunes its parameters based on how much its predictions were close to or far from the actual data. By continuously going through this process, the transformer architecture 400 captures the statistical relations between different words in different contexts. After this pretraining phase, the transformer architecture 400 can be finetuned for a downstream task such as question answering, text summarization, or sentiment analysis by training it on a small number of labeled examples.

In unsupervised learning, the training data 502 is applied as an input to the prediction engine 104, and an error/loss function is generated by comparing a prediction to a known value from the training corpus (e.g., a predicted next word in a text to the actual word in the text). The coefficients of the prediction engine 104 can be iteratively updated to reduce an error/loss function. The value of the error/loss function decreases as outputs from the prediction engine 104 increasingly approximate the training data 502.

For example, in certain implementations, the cost function can use the mean-squared error to minimize the average squared error. In the case of a of multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using any of numerous algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribiére update, Powell-Beale restart, and scaled conjugate gradient). Additionally, evolutionary methods, such as gene expression programming, simulated annealing, expectation-maximization, non-parametric methods, and particle swarm optimization, can also be used for training the prediction engine 104.

The training 508 of the prediction engine 104 can also include various techniques to prevent overfitting to the training data 502 and for validating the trained prediction engine 104. For example, bootstrapping and random sampling of the training data 502 can be used during training.

In addition to supervised learning used to initially train the prediction engine 104, the prediction engine 104 can be continuously trained while being used by using reinforcement learning based on the network measurements and the corresponding configurations used on the network. The prediction engine 104 can be cloud based and can be trained using network measurements and the corresponding configurations from other networks that provide feedback to the cloud.

Further, other machine learning (ML) algorithms can be used for the prediction engine 104, and the prediction engine 104 is not limited to being an ANN. For example, there are many machine-learning models, and the prediction engine 104 can be based on machine-learning systems that include generative adversarial networks (GANs) that are trained, for example, using pairs of network measurements and their corresponding optimized configurations.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 5B illustrates an example of using the trained prediction engine 104. The input data 512 are applied to the trained prediction engine 104 to generate the outputs, which can include the threat vectors 116.

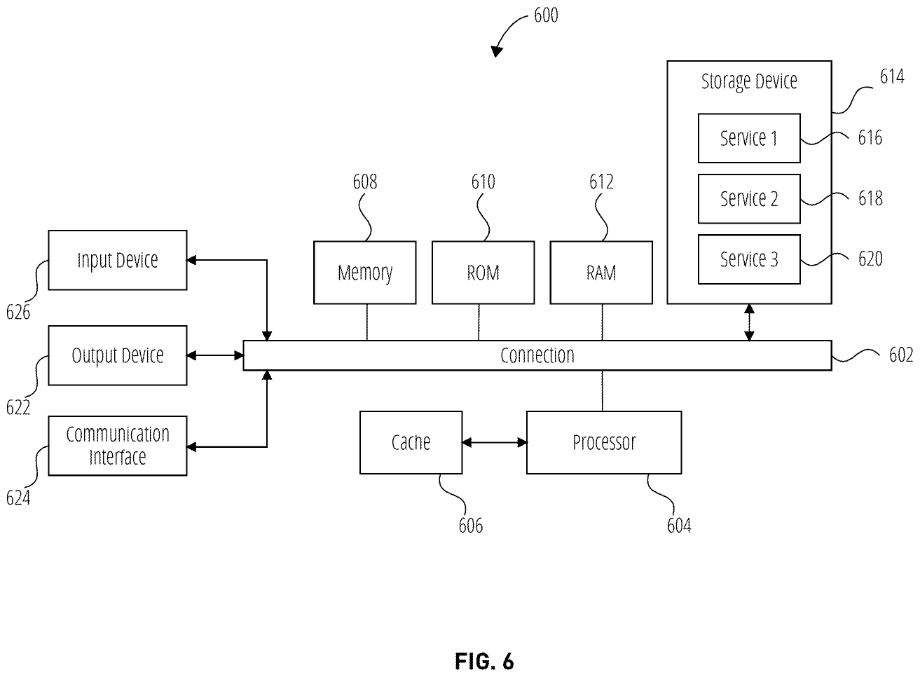

FIG. 6 shows an example of computing system 600, which can be for example any computing device configured to perform one or more of the steps of prediction method 200; any computing device making up the threat vector prediction system 100; or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general-purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, a memory controller, a cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of several output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer-readable media, which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a threat vector prediction system 100 and performs one or more functions of the prediction method 200 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for predicting an exploitation mechanism of a software vulnerability and/or for predicting an impact thereof, the method comprising:
obtaining threat-intelligence information regarding a software vulnerability; and
applying the threat-intelligence information to a machine learning (ML) method to determine a threat vector based on a security category and a data or schema category of the software vulnerability, wherein
the threat vector comprises first indicia that represents an exploitation mechanism of the software vulnerability, and the threat vector comprises second indicia of an impact of the exploitation mechanism of the software vulnerability.

2. The method of claim 1, wherein applying the threat-intelligence information to the ML method further comprises that the ML method including a first portion constrained to predict a first intermediary result corresponding to the security category of the software vulnerability and including a second portion constrained to predict a second intermediary result corresponding to the data or schema category of the software vulnerability, and the ML method predicting a threat vector for the software vulnerability based on the first intermediary result and the second intermediary result.

3. The method of claim 2, wherein applying the threat-intelligence information to the ML method further comprises that the first portion of the ML method comprises a first transformer neural network that predicts, based on a security taxonomy or ontology, a type of security threat of the software vulnerability.

4. The method of claim 3, wherein applying the threat-intelligence information to the ML method further comprises that the second portion of the ML method comprises a second transformer neural network that predicts, based on a data taxonomy or ontology, a type of data set or schema for the software vulnerability.

5. The method of claim 1, wherein applying the threat-intelligence information to the ML method further comprises applying the threat-intelligence information to a classifier that classifies the software vulnerability according to the security category of the software vulnerability and according to the data or schema category of the software vulnerability.

6. The method of claim 1, wherein the ML method has been trained using labeled training data that includes training threat-intelligence information that is labeled according to threat vectors, security categories, and data or schema categories.

7. The method of claim 1, wherein
the threat vector comprises the first indicia that is selected from the group consisting of a STRIDE threat category, a common vulnerability scoring system (CVSS) vector, a vulnerability type, the exploitation mechanism, an exploitation entry point, and MITRE ATT&CK framework tactics and techniques.

8. The method of claim 1, further comprising:
providing the threat vector to a remediation processor; and
performing, by the remediation processor, a remediating action based on the threat vector.

9. The method of claim 8, wherein the remediating action is selected from the group consisting of quarantining a computer implementable instruction corresponding to the software vulnerability, installing a software patch, updating and/or upgrading software corresponding to the software vulnerability, defending privileges and/or accounts, enforcing signed software execution policies, exercising a recovery plan, managing systems and/or configurations, searching or scanning for network intrusions, engaging hardware security features, increasing segregation of networks and processors, and transitioning to multi-factor authentication.

10. The method of claim 1, further comprising:
signaling the threat vector to a user;
receiving user feedback regarding values of the threat vector; and
performing reinforcement learning based on the received user feedback to update the ML method.

11. The method of claim 10, further comprising:
prior to receiving the user feedback, verifying, based on login credentials of the user, that the user is authorized to provide the user feedback.

12. A computing apparatus comprising:
a processor; and
a memory storing instructions that, when executed by the processor, configure the apparatus to:
obtain threat-intelligence information regarding a software vulnerability; and
apply the threat-intelligence information to a machine learning (ML) method to determine a threat vector based on a security category and a data or schema category of the software vulnerability, wherein
the threat vector comprises first indicia that represents an exploitation mechanism of the software vulnerability, and the threat vector comprises second indicia that represents an impact of the exploitation mechanism of the software vulnerability.

13. The computing apparatus of claim 12, wherein, when executed by the processor, the stored instructions further configure the apparatus to:
apply the threat-intelligence information to the ML method such that:
the ML method includes a first portion constrained to predict a first intermediary result corresponding to the security category of the software vulnerability,
the ML method includes a second portion constrained to predict a second intermediary result corresponding to the data or schema category of the software vulnerability, and
the ML method is configured to predict a threat vector for the software vulnerability based on the first intermediary result and the second intermediary result.

14. The computing apparatus of claim 13, wherein, when executed by the processor, the stored instructions further configure the apparatus to:
apply the threat-intelligence information to the ML method such that the first portion of the ML method comprises a first transformer neural network that predicts, based on a security taxonomy or ontology, a type of security threat of the software vulnerability.

15. The computing apparatus of claim 14, wherein, when executed by the processor, the stored instructions further configure the apparatus to:
apply the threat-intelligence information to the ML method such that the second portion of the ML method comprises a second transformer neural network that predicts, based on a data taxonomy or ontology, a type of data set or schema for the software vulnerability.

16. The computing apparatus of claim 12, wherein, when executed by the processor, the stored instructions further configure the apparatus to:
apply the threat-intelligence information to the ML method by applying the threat-intelligence information to a classifier that classifies the software vulnerability according to the security category of the software vulnerability and according to the data or schema category of the software vulnerability.

17. The computing apparatus of claim 12, wherein the ML method has been trained using labeled training data that includes training threat-intelligence information that is labeled according to threat vectors, security categories, and data or schema categories.

18. The computing apparatus of claim 12, wherein the threat vector comprises the first indicia that is selected from the group consisting of a STRIDE threat category, a common vulnerability scoring system (CVSS) vector, a vulnerability type, the exploitation mechanism, an exploitation entry point, and MITRE ATT&CK framework tactics and techniques.

19. The computing apparatus of claim 12, wherein, when executed by the processor, the stored instructions further configure the apparatus to:
provide the threat vector to a remediation processor; and
perform, by the remediation processor, a remediating action based on the threat vector.

20. The computing apparatus of claim 19, wherein the remediating action is selected from the group consisting of quarantining a computer implementable instruction corresponding to the software vulnerability, installing a software patch, updating and/or upgrading software corresponding to the software vulnerability, defending privileges and/or accounts, enforcing signed software execution policies, exercising a recovery plan, managing systems and/or configurations, searching or scanning for network intrusions, engaging hardware security features, increasing segregation of networks and processors, and transitioning to multi-factor authentication.
